(19) United States
(12) Patent Application Publication
(10) Pub. No.: US 2014/0118990 A1
(43) Pub. Date: May 1, 2014

(54) LED MODULE

(71) Applicant: No Chul KI, Gyeonggi-do (KR)

(72) Inventor: No Chul KI, Gyeonggi-do (KR)

(21) Appl. No.: 13/664,105

(22) Filed: Oct. 30, 2012

(51) Int. Cl. F21V 9/16

(52) U.S. Cl. 362/84

(57) ABSTRACT

A light emitting diode (LED) module is provided that emits uniform light in terms of the distribution of diffused light. The LED module comprises: a base plate integrally formed with electrical wires via an injection molding, wherein the base plate forms a reception space; a plate on which a number of LEDs are installed, wherein the plate is placed in the reception space of the base plate; bolts coupling the plate to the base plate; a cover that is fixed to the base plate via ultrasonic welding; and a lens part that is formed in the cover via a double injection molding, wherein the lens part comprises fluorescent materials and has various colors.

### BACKGROUND OF THE INVENTION

1. Field of the Invention

This invention relates to signs, and more particularly, to a light emitting diode (LED) module with florescent lenses that can emit uniform light in terms of the distribution of diffused light.

2. Description of the Related Art

Light Emitting Diode (LED) modules are in general installed to signs for advertisements or walls that require illumination. An LED module includes a base plate, shaped as a box where the top side is opened; an LED plate, fixed in the base plate, including a number of LEDs; and an electric wire for supplying electric power to the LED plate.

The LED module is configured so that the LED plate is exposed to the outside. When an epoxy is applied to the base plate where electric wires are buried so that it can be filled such an extent to cover the surface of the exposed LED plate, the exposed LED plate can be protected. LED modules are fixed to signs for advertisements or walls that require illumination, via fixing members.

However, conventional LED modules are disadvantageous in that, since they employ expensive epoxies to fix the components, the manufacturing costs are high. Although LED modules are filled with expensive epoxies, the filled amount of epoxy cannot be detected. Therefore, epoxy may be exceedingly or insufficiently filled in the LED module or the filled epoxy may be cured at one side in the LED module. These deteriorate the quality of LED modules, e.g., waterproof performance, product reliability, etc.

If the LED module is filled with epoxy to the extent of the surface of the LED plate, cracks are created on the cured epoxy during usage. Since foreign substances, such as water, dust, etc., easily invade the cracks, the LED plate may be damaged.

Since LEDs on the LED plate are coated with epoxy when it fills the LED module, this reduces the uniformity of the distribution of diffused light in the LED module.

In addition, since epoxy filling the LED module requires approximately 24 hours to be cured, it takes a long time to manufacture an LED module.

### SUMMARY OF THE INVENTION

The invention has been made in view of the above problems, and provides a light emitting diode (LED) module that is fixed to a base plate with an LED plate, via a cover with lenses, so that it can be protected from foreign substances, e.g., water, dust, etc.

The invention further provides an LED module that can be manufactured at a relatively low cost.

The invention further provides an LED module that has a uniform diffused light and a wide range of distribution of diffused light.

The invention further provides an LED module that can be manufactured in a relatively short time.

In accordance with an exemplary embodiment of the invention, the invention provides an LED module comprises: a base plate integrally formed with electrical wires via an injection molding, wherein the base plate forms a reception space; a plate on which a number of LEDs are installed, wherein the plate is placed in the reception space of the base plate; bolts coupling the plate to the base plate; a cover that is fixed to the base plate via ultrasonic welding; and a lens part that is formed in the cover via a double injection molding, wherein the lens part comprises fluorescent materials and has various colors. Preferably, the bolts electrically connects the plate to the wires.

Preferably, the lens part comprises: lenses for covering and protecting the LEDs of the plate, where the lenses are transparent; and communication units for connecting the lenses. The base plate forms placements on which the plate is placed. The placements each form guide holes, wherein the guide holes are each formed as lengthwise holes so that they can be coupled to the fasteners at corresponding locations according to the size of the plate. The base plate forms a coupling groove on the top of the edge part along the periphery. The cover forms a coupling protrusion on the top of the edge part along the periphery. The coupling protrusion is coupled to the coupling groove.

### BRIEF DESCRIPTION OF THE DRAWINGS

The features and advantages of the invention will become more apparent from the following detailed description viewed in conjunction with the accompanying drawings, in which:

FIG. 1 illustrates a perspective view of an LED module according to an embodiment of the invention;

FIG. 2 illustrates an exploded perspective view of an LED module according to an embodiment of the invention; and

FIG. 3 illustrates a cross-section view of an LED module according to an embodiment of the invention.

### DETAILED DESCRIPTION OF EXEMPLARY EMBODIMENTS

Hereinafter, exemplary embodiments of the invention are described in detail with reference to the accompanying drawings. Although the drawings represent an embodiment of the invention, the drawings are not necessarily to scale and certain features may be exaggerated or omitted in order to better illustrate and explain the invention.

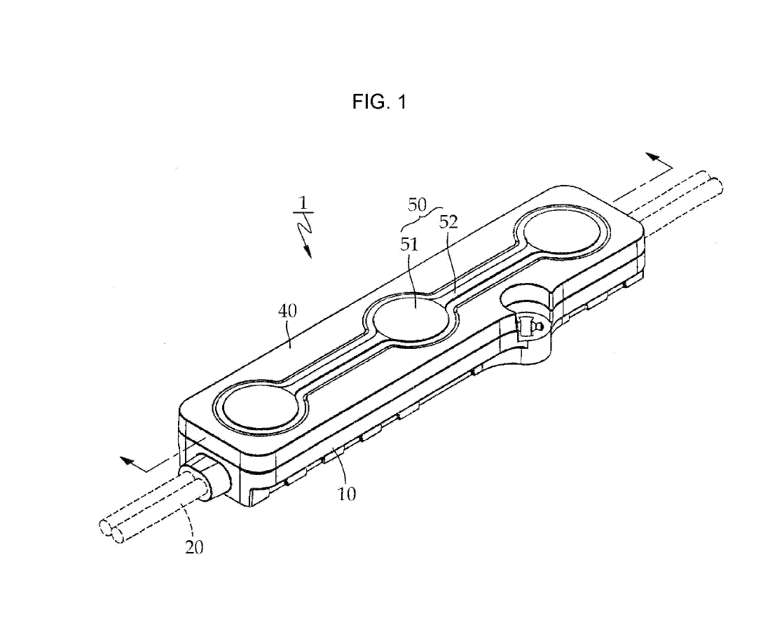

As shown in FIGS. 1 to 3, the LED module 1 comprises a base plate 10, a plate 30, a cover 40 and a lens part 50.

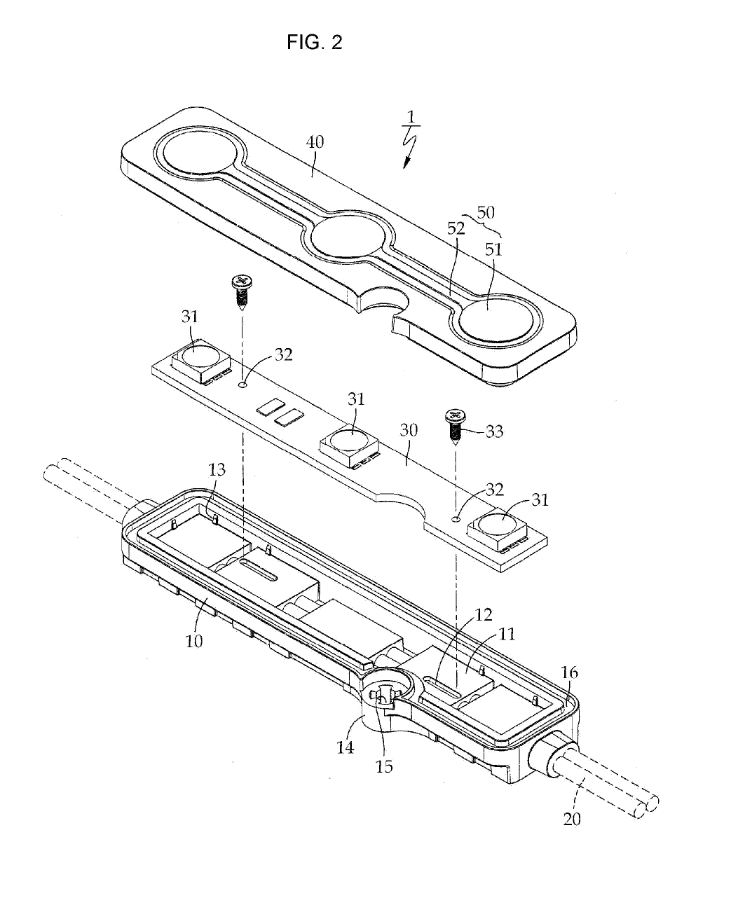

As shown in FIGS. 1 and 2, the base plate 10 is integrally coupled with wires 20 via an injection molding. That is, the wires 20 are injected inside the base plate 10, so that they are integrally formed as a body.

The base plate 10 is shaped as a box where the top side is opened, forming a reception space.

The base plate 10 forms a number of placements 11, shaped as blocks, on the bottom. The placements 11 are located spaced apart from each other at a certain distance. The wires 20 are located between the placements 11 and the base plate 10.

Each placement 11 forms a guide hole 12 at one side thereon. The guide hole 12 is coupled with a bolt 33 that will be described later. The guide hole 12 is shaped as a lengthwise hole along the lengthwise direction of the base plate 10.

The guide hole 12 allows the bolt 33 to adjust the position to be coupled therewith because it is a lengthwise hole. This configuration allows for the installation of a variety of different sized plates 30 to the base plate 10. For example, if the plate 30 has a size similar to the inner size of the base plate 10, the bolts inserted to the plate 30 are located at both outer ends of the guide holes 12, which are farthest from each other, and coupled thereto. Likewise, if the plate 30 has a size relatively smaller than the inner size of the base plate 10, the bolts inserted to the plate 30 are located at both inner ends of the guide holes 12, which are closest to each other, and coupled thereto.

As shown in FIG. 2, the base plate 10 forms a number of fixing protrusions 13 protruded on the inner wall of the base plate 10, at positions corresponding to the upper portion of the placement 11. The fixing protrusions 13 temporarily fixes the plate that is fitted into the base plate 10. Each of the fixing protrusions 13 is shaped in such a way that it is more protrudent from the top to the bottom, forming a slope.

The base plate 10 also forms a fixing part 14 on the outer side in such a way that it is protruded from the outer side wall. The fixing part 14 is used to fix the LED module 1 to a corresponding place, such as a sign or a location that requires illumination. The fixing part 14 may form a through hole 15 in the center that allows a fixing member (not shown), e.g., a bolt, etc., to pass through. Therefore, the LED module 1 can easily be installed to a corresponding place via the fixing part 14.

The base plate 10 also forms a coupling groove 16 on the top of the edge part along the periphery, which is coupled to a coupling protrusion 41 of the cover that will be described later.

As shown in FIG. 2, the plate 30 is shaped to correspond to the inner reception space of the base plate 10. The plate 30 includes a number of LEDs 31, spaced apart from each other at a preset interval, on the upper side. The plate 30 also forms coupling holes 32 between the LEDs 31, to which bolts 33 are inserted. When the bolts 33 are coupled with the coupling holes 32, the plate 30 is fixed onto the placement 11 of the base plate 10.

The coupling holes 32 are formed in parallel. It should be understood that the bolts 33 coupled to the coupling holes 32 may be implemented with various types of fasteners if they fix the plate 30 to the base plate 10.

For example, if two bolts 33 are coupled to the coupling holes 32 respectively, one is connected to a positive wire and the other is also connected to a negative wire, serving as an electrode, thereby electrically connecting the wire 20 to the plate 30. To this end, the portions around the coupling holes 32 of the plate 30 may be made of conductive materials such as copper, metal film, etc., so that the plate 30 can be electrically connected to the wires via the bolts 33.

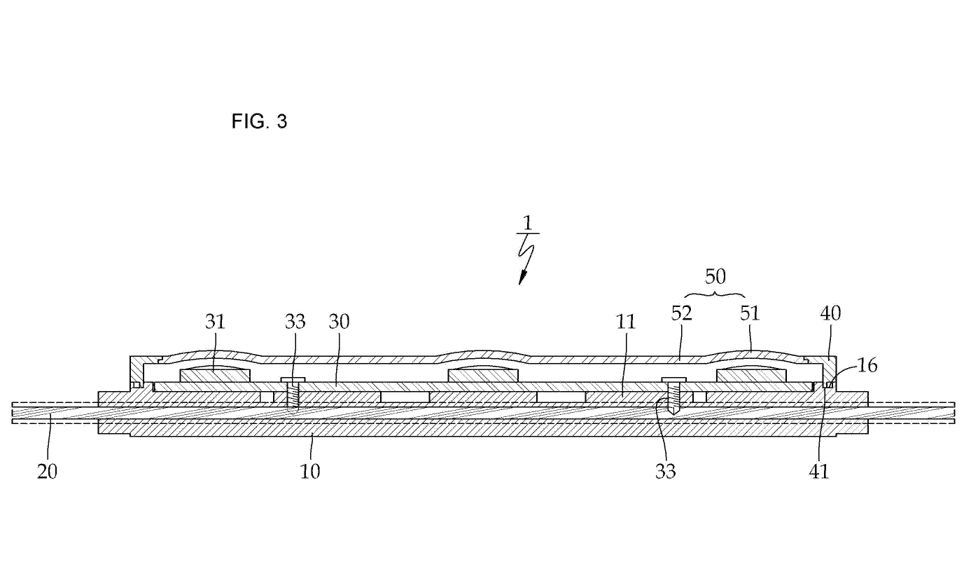

As shown in FIG. 2, the cover 40 is placed on the opened top side of the base plate 10. The cover 40 is manufactured in an injection molding method in such a way that the lower side facing the base plate 10 is hollow as shown in FIG. 3.

The cover 40 forms a coupling protrusion 41 on the top of the edge part along the periphery. The coupling protrusion 41 is coupled to the coupling groove 16 of the base plate 10 in such a way that it is fitted into the coupling groove 16. When the coupling protrusion 41 is coupled to the coupling groove 16, the cover 40 is thus coupled to the base plate 10 as shown in FIG. 3. The contact line between the coupling protrusion 41 and the coupling groove 16 is welded via an ultrasonic welding method.

As such, since the base plate 10 and the cover 40 are integrally welded as one body, the LED module 1 is airtight and watertight, so that it can protect the LED plate 30 against foreign substances such as water, dust, etc.

In addition, since the base plate 10 and the cover 40 are integrally welded via a welding method, unlike conventional art that applies epoxies to the components, the LED module 1 according to the invention is manufactured to be lightweight and also with relatively low manufacturing costs. The LED module 1 can also protect workers against an electric shock during the operation of the module. The LED module 1 reduces manufacturing time and makes it possible to use an automated manufacturing process because it doesn't use epoxies. [Para 35] The lens part 50 is formed in the cover 40 via a double injection molding method. The lens part 50 may be formed to include fluorescent materials of various colors, so that it has respective colors. The lens part 50 includes lenses 51 for protecting the LEDs 31 of the plate 30 and communication units 52 for connecting the lenses 51. As shown in FIG. 3, it is preferable that each of the lenses 51 is slightly convex and each of the communication units 51 is flat.

LEDs 31 of the plate 30 emit light through the lenses 51 of the lens part 50 in various colors. LEDs 31 also emit light smoothly, naturally, via the communication units 52. Therefore, the LED module 1 can emit light uniformly and widely.

Since the cover includes the lens parts 50, it can prevent a rapid degradation of the LEDs 31. Since LEDs 31 are not directly touched by workers, they can prevent any change in color or deformation in shape.

The LED module 1 configured as described above is assembled with the components as follows. The LED plate 30 is inserted in the base plate 10 where the base plate 10 with the wires 20 is formed via an injection molding method.

The plate 30 is fitted to the base plate 10 via the fixing protrusions 13 formed on the inner wall of the base plate 10, and then placed on the placements 11. In that case, the coupling holes 32 of the plate 30 are located to correspond to the guide holes 12 of the placements 11. The wires 20 are located between the placements 11 and the base plate 10.

After that, the bolts 33 are coupled through the coupling holes 32 to the guide holes 12. In that case, the bots 33 fix the plate 30 to the placement 11 of the base plate 10 and are connected through the covering materials to the positive and negative wires, thereby electrically connecting the plate 30 to the wires 20.

After that, the cover 40 with the lens parts 50 is coupled to the base plate 10 in such a way that the coupling protrusion 41 of the cover 40 is fitted into the coupling groove 16 of the base plate 10. After that, the contact line between the coupling protrusion 41 and the coupling groove 16 is welded via an ultrasonic welding method.

Therefore, the LED module 1 is configured in such a way that the lenses 51 of the lens part 50 are located at positions to correspond to the LEDs of the base plate 10 and the lenses 51 are communicated via the communication units 52. When LEDs 31 are turned on, the light is emitted via the lenses 51 and the communication units 52, and this makes it possible to achieve a uniform distribution of diffused light.

The LED module 1 assembled as described above is installed to a sign or a place that requires illumination in such a way that the fastener such as screws or bolts is coupled through the through holes 15 of the fixing part 14 of the base plate 10 to the corresponding sign or place.

Since the LED module 1 is airtight and watertight, its life span is relatively long.

As described above, since the LED module according to the invention is fixed to the base plate with an LED plate, via a cover with lenses is fixed, unlike conventional art where it is filled with epoxy, the LED module: is airtight and watertight, so that the LED plate can be protected against foreign substances, such as water, dust, etc.; is manufactured at a relatively low cost; and is lightweight.

Since the cover with lenses is fixed to the base plate, workers can be protected against an electric shock during the operation of the LED module.

Since a lens part installed to the cover includes lenses covering LEDs and communication units for connecting the lenses, the LEDs emit light via the lenses and the communication units, so that the light can be uniformly and widely diffused and rapid degradation can be prevented. In addition, since LEDs are not directly touched by workers, they can prevent any change in color or deformation in shape.

The LED module can be manufactured via a simple process where the cover with lenses is fixed to the base plate with an LED plate via an ultrasonic welding, and this reduces the manufacturing time and makes it possible to achieve an automated manufacturing process.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

What is claimed is:

1. A light emitting diode (LED) module comprising:
a base plate integrally formed with electrical wires via an injection molding, wherein the base plate forms a reception space;
a plate on which a number of LEDs are installed, wherein the plate is placed in the reception space of the base plate;
bolts coupling the plate to the base plate;
a cover that is fixed to the base plate via ultrasonic welding; and
a lens part that is formed in the cover via a double injection molding, wherein the lens part comprises fluorescent materials and has various colors.

2. The LED module of claim 1, wherein the bolts electrically connect the plate to the wires.

3. The LED module of claim 1, wherein the lens part comprises:
lenses for covering and protecting the LEDs of the plate, where the lenses are transparent; and
communication units for connecting the lenses.

4. The LED module of claim 1, wherein:
the base plate forms placements on which the plate is placed; and
the placements each form guide holes, wherein the guide holes are each formed as lengthwise holes so that they can be coupled to the fasteners at corresponding locations according to the size of the plate.

5. The LED module of claim 1, wherein:
the base plate forms a coupling groove on the top of the edge part along the periphery;
the cover forms a coupling protrusion on the top of the edge part along the periphery; and
the coupling protrusion is coupled to the coupling groove.
